(19) United States
(12) Patent Application Publication
(10) Pub. No.: US 2026/0105033 A1
(43) Pub. Date: Apr. 16, 2026

(54) SYSTEMS AND METHODS FIT-FOR-PURPOSE DATABASE SELECTION BASED ON APPLICATION CHARACTERISTICS AND DEVELOPMENT TIMELINES OF APPLICATIONS CURRENTLY UNDER DEVELOPMENT

(71) Applicant: Capital One Services, LLC, McLean, VA (US)

(72) Inventors: Nitin SHARMA, Henrico, VA (US); Preston BURROUGHS, Newark, DE (US); Manish ARORA, Middletown, DE (US); Fantahun Aberra ZIKIE, Clarksburg, MD (US); Volkan SENKAYNAK, Wilmington, DE (US); Mayankkumar DESAI, Haddon Township, NJ (US)

(73) Assignee: Capital One Services, LLC, McLean, VA (US)

(21) Appl. No.: 18/913,987

(22) Filed: Oct. 11, 2024

(51) Int. Cl. G06F 16/21; G06F 16/23; G06F 16/248

(52) U.S. Cl. CPC G06F 16/213; G06F 16/2365; G06F 16/248

(57) ABSTRACT

The system may receive an application for fitting to one of a plurality of database engines based on a requirement for the application. The system may filter the plurality of database engines based on the requirement to generate a first subset of database engines. The system may determine a first characteristic of a schema of the application. The system may determine a percentage of completeness of the schema based on the first characteristic. The system may select a first database engine from the first subset of database engines, based on the percentage of completeness of the schema. The system may generate for display, on a user interface a recommendation for the first database engine.

### BACKGROUND

A database engine, also known as a database management system (DBMS), is the underlying software component that interacts with the database to store, retrieve, and manage data. It provides the core functionality for database operations, including creating, reading, updating, and deleting records. The database engine ensures data integrity, security, and consistency by managing transactions, enforcing data rules, and providing access control. It also optimizes query performance through indexing, caching, and query optimization techniques. Different engines offer unique features and capabilities tailored to different types of applications and use cases, from small-scale web applications to large enterprise systems.

An improper database engine can lead to slow query responses and data corruption issues due to several factors. Firstly, an inefficient engine may lack robust optimization techniques, resulting in poor query performance. Without effective indexing, caching, and query optimization, the engine struggles to retrieve data quickly, causing delays and slow response times. Additionally, a subpar engine might not handle concurrent transactions well, leading to deadlocks or race conditions that can further degrade performance. Data corruption issues arise when the engine fails to maintain data integrity and consistency, often due to inadequate transaction management and error handling. For instance, in the event of a system crash or power failure, a reliable engine should ensure data recovery and rollback incomplete transactions, whereas an improper engine might leave the database in an inconsistent state. Furthermore, without strong access control and validation mechanisms, an inferior engine may allow unauthorized access or erroneous data entries, compromising the database's accuracy and reliability. Thus, choosing the right database engine is crucial for maintaining optimal performance and data integrity.

### SUMMARY

Systems and methods are described herein for novel uses and/or improvements to database selection tools, in particular through the use of artificial intelligence applications. More specifically, the systems and methods are described herein for a database selection tool for applications currently under development. For example, selecting the correct database engine for an application is technically challenging due to the diverse and specific requirements each application may have. Applications vary widely in terms of data volume, complexity, and/or usage patterns, necessitating a deep understanding of the database engine's capabilities and limitations. Developers must consider factors such as scalability, performance, data consistency, security, and/or compatibility with existing systems. For instance, an application with high transaction rates demands an engine with robust concurrency control and efficient indexing, while one with complex analytical queries might require advanced data processing capabilities. Additionally, the future growth of the application must be anticipated, ensuring the chosen engine can scale appropriately without compromising performance. Different database engines may offer unique features and capabilities tailored to the different types of applications, use cases, and the individual requirements of these application and use cases.

These technical challenges are further exacerbated applications currently under development as the landscape of both database technologies and features of a given application are continuously evolving, with new features and improvements regularly introduced, making it difficult to stay current and make an informed choice. Balancing all these considerations, along with budget constraints and development timelines, adds to the complexity of selecting the most suitable database engine. For example, selecting a specific database engine to soon in the development lifecycle of an application may result in the application being optimized for an obsolete database engine and/or lacking the compatibility with newly released versions. As another example, selecting the specific database engine to soon in the development lifecycle may cause the application to lose the opportunity to select a database engine featuring better (e.g., newly released) features. As yet another example, selecting the specific database engine to soon in the development lifecycle may cause the decision to use a specific database engine being determine prior to a final feature list of the application. Thus, the application may be designed to use a database engine that does not support its features.

In contrast, waiting until later in the development cycle to select the correct database engine for an application can be technically problematic for several reasons. Early decisions about the database architecture significantly impact the overall design and functionality of the application. If the database engine is chosen late, it may require substantial refactoring of the codebase to integrate properly, leading to increased development time and costs. Additionally, late selection can uncover compatibility issues with the chosen database engine, necessitating significant changes in data models, queries, and transaction handling logic. This can disrupt the development workflow and introduce bugs and performance bottlenecks that are difficult to resolve. Moreover, different database engines have unique features and limitations; choosing one later in the process might mean missing out on optimization opportunities that could have been built into the application from the start. Furthermore, late selection can delay performance testing and tuning, which are critical to ensuring the application meets its performance and scalability requirements. Ultimately, waiting too long to select the correct database engine can result in a less efficient, more error-prone application, and potentially compromise the project's success.

In view of this tension between selecting a database engine too soon or too late, the system and methods provide a database selection tool, in particular through the use of artificial intelligence applications. More specifically, the systems and methods provide a fit-for-purpose database selection based on application characteristics and development timelines of applications currently under development. By doing so, the systems and methods both balance the tension between selecting a database engine too soon or too late as well as ensure that a database engine that is eventually selected fits for the current purposes of the application. To achieve these technical benefits, the system (e.g., as power by an artificial intelligence model) may determine a completeness of an application (e.g., based on the completeness of its schema) and select a database engine based on that completeness. By doing so, the system may not only determine an optimal time to make a database engine selection, but also what requirements the deployed application may have. For example, the system may select the time based on balancing the risk of encountering performance issues or data inconsistencies later in the development cycle as the engine is tailored to the application's specific requirements from the outset with the risk that the application's features may eventually change requiring a different database engine. Additionally or alternatively, as the application nears completion and/or a current set of features is known, the system may determine the likelihood that new and/or different features, objectives, etc., are likely to be added (or not added). The system may use these new and/or different features (and their respective likelihoods) as weights to a selection process.

In some aspects, systems and methods method for fit-for-purpose database selection based on application characteristics of applications currently under development are described. For example, the system may receive an application for fitting to one of a plurality of database engines based on a requirement for the application. The system may filter the plurality of database engines based on the requirement to generate a first subset of database engines. The system may determine a first characteristic of a schema of the application. The system may determine a percentage of completeness of the schema based on the first characteristic. The system may select a first database engine, from the first subset of database engines, based on the percentage of completeness of the schema. The system may generate for display, on a user interface a recommendation for the first database engine.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a fit-for-purpose database selection based on application characteristics, in accordance with one or more embodiments.

FIG. 2 shows an illustrative diagram for a user interface used to receive application requirements, in accordance with one or more embodiments.

FIG. 3 shows illustrative components for a system used for database selection, in accordance with one or more embodiments.

FIG. 4 shows a flowchart of the steps involved in database selection, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

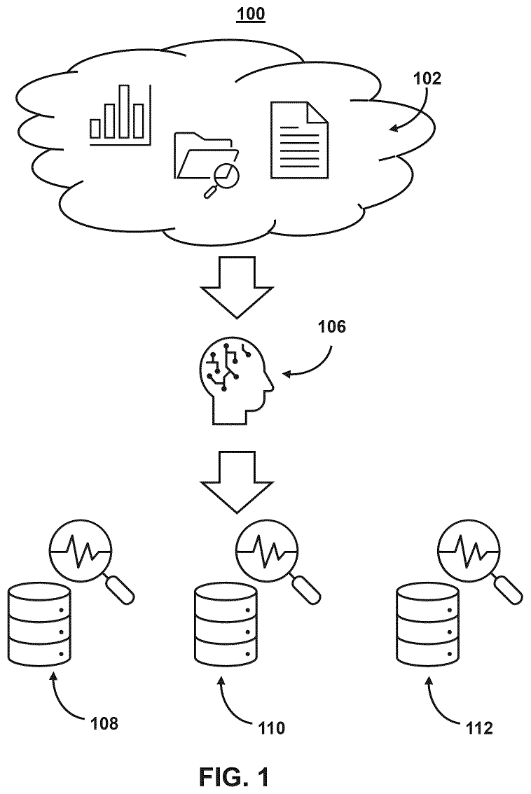

FIG. 1 shows an illustrative diagram for a fit-for-purpose database selection based on application characteristics, in accordance with one or more embodiments. For example, diagram 100 may comprise components used for fit-for-purpose database selection based on application characteristics. The systems and methods both balance the tension between selecting a database engine too soon or too late as well as ensure that a database engine that is eventually selected fits for the current purposes of the application.

As shown in FIG. 1, diagram 100, system 106 may receive application 102 for matching to one or more of database engines (e.g., database engine 108, database engine 110, and/or database engine 112). Application 102 may comprise a plurality of application characteristics. As referred to herein, an “application characteristic” may include any characteristics about an application and/or information related to the application.

For example, characteristics of an application may be useful in selecting the appropriate database engine to ensure optimal performance, scalability, and/or reliability. Characteristics may relate to the nature and volume of the data. For example, applications with high transaction volumes, such as e-commerce platforms or financial systems, may require a database engine that supports robust transaction management and concurrency control. In contrast, applications dealing with large amounts of unstructured data, like social media platforms or content management systems, may benefit from a NoSQL database that can handle flexible schemas and horizontal scaling.

Another example characteristic may relate to the complexity and frequency of queries. Applications that perform complex queries involving multiple joins, aggregations, and analytical processing need a database engine with advanced query optimization and indexing capabilities. Conversely, applications with simpler query requirements might prioritize other factors, such as ease of use or cost-effectiveness. The expected growth and scalability needs of the application also play a significant role. Applications anticipated to scale rapidly must select a database engine that can efficiently handle increased loads and data growth without significant performance degradation. This includes considering the database's ability to scale horizontally across multiple servers or vertically by upgrading hardware.

Additionally, the consistency and availability requirements of the application influence the choice of the database engine. Applications needing strong consistency, such as financial transactions or inventory management systems, might prefer relational databases with Atomicity, Consistency, Isolation, Durability (ACID) properties. In contrast, applications that prioritize availability and partition tolerance, such as distributed systems or IoT platforms, might opt for eventually consistent NoSQL databases.

Other factors include the application's security requirements, compatibility with existing technology stacks, and the team's familiarity with the database technology. Security-conscious applications, such as those in healthcare or finance, need databases with robust security features, including encryption, access control, and audit logging. Performance requirements, such as response time and throughput, may also be considered. Applications requiring real-time data access and low-latency responses, such as gaming or streaming services, necessitate a high-performance database engine optimized for quick read and write operations.

In some embodiments, the system may monitor content generated and/or used by the application to generate application profile data. As referred to herein, “an application profile” and/or “application profile data” may comprise data actively and/or passively collected about an application. For example, the application profile data may comprise content generated by the application and an application characteristic for the application. An application profile may be content consumed and/or created by an application. For example, an application profile may have the settings for the application's installed programs and operating system. In some embodiments, the application profile may be a visual display of personal data associated with a specific application, or a customized desktop environment. In some embodiments, the application profile may be digital representation of an application's identity. The data in the application profile may be generated based on the system actively or passively monitoring.

System 106 may determine a completeness of an application (e.g., based on the completeness of its schema) and select a database engine based on that completeness. For example, system 106 may not only determine an optimal time to make a database engine selection, but also what requirements the deployed application may have.

System 106 may also determine one or more characteristics about one or more database engines (e.g., database engine 108, database engine 110, and/or database engine 112). As referred to herein, “a database engine characteristic” may include information about a database engine and/or information related to the database engine settings, preferences, and/or information for the database engine. The system may also store one or more database engine profiles. The system may monitor content used by the database engine to generate application profile data. As referred to herein, “a database engine profile” and/or “database engine profile data” may comprise data actively and/or passively collected about a database engine. For example, the database engine profile data may comprise content generated by the database engine and a database engine characteristic for the database engine. A database engine profile may be content consumed and/or created by a database engine.

For example, a database engine profile may have the settings for the database engine's installed programs and operating system. In some embodiments, the database engine profile may be a visual display of personal data associated with a specific database engine, or a customized desktop environment. In some embodiments, the database engine profile may be digital representation of the database engine's identity. The data in the database engine profile may be generated based on the system actively or passively monitoring.

As shown in FIG. 1, system 106 may receive application 102 for fitting to one of a plurality of database engines (e.g., database engine 108, database engine 110, and/or database engine 112) for use by application 102 across a cloud computing network after deployment of application 102. To select a database engine, the system may use various factors.

In some embodiments, system 106 may select the time based on balancing the risk of encountering performance issues or data inconsistencies later in the development cycle as the engine is tailored to the application's specific requirements from the outset with the risk that the application's features may eventually change requiring a different database engine. For example, system 106 may select an optimal time for choosing a database engine by carefully balancing the risks of encountering performance issues or data inconsistencies later in the development cycle against the possibility that the application's features may evolve, necessitating a different database engine. This balancing act may involve a strategic approach that integrates continuous evaluation and adaptability throughout the development process.

System 106 may conduct a thorough assessment of the application's current requirements, including data volume, query complexity, transaction frequency, and scalability needs. By understanding these parameters early on, the system can make an informed initial choice of a database engine that aligns with the application's immediate demands. During this phase, the system prioritizes database engines known for their flexibility and ability to handle a wide range of scenarios, thereby reducing the risk of performance bottlenecks and data inconsistencies.

To address the risk of evolving application features, system 106 may implement a continuous integration and continuous deployment (CI/CD) pipeline that includes regular performance evaluations and testing cycles. As the application evolves and new features are added, the system continuously monitors how these changes impact the database performance and overall application functionality. This iterative approach allows the system to detect and address potential issues early, ensuring the database engine remains well-suited to the application's needs. Moreover, the system employs a modular and decoupled architecture, which facilitates easier transitions between different database engines if necessary. By designing the application with abstraction layers and database-agnostic interfaces, the system minimizes the effort required to switch engines, should future requirements demand a change. This architectural flexibility provides a safety net, allowing the system to adapt to unforeseen changes in application features without significant disruption.

System 106 may also leverage predictive analytics and machine learning models to forecast potential changes in application requirements based on historical data and usage patterns. These models help anticipate future scalability needs, feature expansions, and performance challenges, allowing the system to make proactive adjustments to the database engine choice. By combining an initial informed decision with continuous monitoring, adaptive architecture, and predictive analytics, the system effectively balances the need to tailor the database engine to the application's specific requirements from the outset with the flexibility to accommodate future changes. This strategic approach ensures optimal performance, data integrity, and scalability throughout the application's lifecycle, mitigating the risks associated with both premature and delayed database engine selection.

As the application nears completion and/or a current set of features is known, system 106 may determine the likelihood that new and/or different features, objectives, etc., are likely to be added (or not added). The system may use these new and/or different features (and their respective likelihoods) as weights to a selection process.

For example, system 106 selects a database engine for an application by determining the likelihood that new or different features and objectives will be added during development, as well as by assigning weights to these features and their respective likelihoods in the selection process. This approach involves several key steps that integrate data analysis, predictive modeling, and decision-making frameworks. For example, the system collects extensive data on past projects, including feature additions, changes in objectives, and the evolution of application requirements over time. This historical data is analyzed to identify patterns and trends that indicate how often and under what circumstances new features and objectives tend to emerge during development. Using this information, the system employs machine learning algorithms to build predictive models that estimate the likelihood of similar changes occurring in the current project. These models consider various factors such as project type, industry, development team, and market conditions.

Once the likelihood of new or different features is determined, the system evaluates the potential impact of these features on the database engine selection. This involves assessing how different database engines handle specific requirements such as data volume, query complexity, transaction rates, and scalability. For instance, if the predictive model suggests a high likelihood of adding features that require complex data relationships and transactions, a relational database engine might be more suitable. Conversely, if the likelihood of incorporating features that involve large-scale unstructured data is high, a NoSQL database could be a better fit.

To quantify the importance of these predicted features and their likelihoods, the system assigns weights to each feature based on its expected impact on the application's performance and requirements. These weights are derived from the historical data analysis and expert input, reflecting the criticality and influence of each feature on the overall system design. The weighting process involves prioritizing features that are deemed essential for the application's core functionality and those likely to have the most significant impact on database performance and scalability.

With the likelihoods and weights established, the system integrates this information into a multi-criteria decision-making framework. This framework evaluates different database engines against a set of criteria, weighted according to the predicted features and their likelihoods. By scoring each database engine based on how well it meets the weighted criteria, the system can identify the most suitable engine that balances current requirements with the flexibility to accommodate future changes.

The system may select a database engine by leveraging predictive models to estimate the likelihood of new or different features and objectives being added during development. It assigns weights to these features based on their expected impact and importance and uses a decision-making framework to evaluate and score different database engines. This approach ensures that the selected database engine is not only well-suited to the application's current needs but also flexible enough to adapt to future changes, optimizing performance, scalability, and data integrity throughout the development lifecycle.

In some embodiments, the system may determine a percentage of completeness of the schema based on the first characteristic. A schema of an application domain may be defined by several characteristics that ensure it accurately represents and supports the application's data requirements. For example, entities and their attributes form the foundation, representing the core objects and their properties within the domain. Each entity should be clearly defined, with attributes specifying the data type and constraints such as length or permissible values. Secondly, the relationships between entities are crucial, detailing how entities interact with each other through associations like one-to-one, one-to-many, and many-to-many relationships. These relationships should be explicitly defined using foreign keys and relationship tables where necessary.

Constraints and rules form another characteristic, ensuring data integrity and enforcing business rules. This includes primary keys for unique identification, foreign keys for referential integrity, unique constraints to prevent duplicate entries, and check constraints to validate data. Indexing is also a critical aspect, enhancing the performance of data retrieval operations by providing efficient access paths to the data.

Normalization is another characteristic that ensures the schema is free from redundant data and is logically organized, typically through various normal forms (1NF, 2NF, 3NF, etc.). Denormalization may also be employed strategically to improve performance in specific scenarios. The schema should also be extensible and scalable, allowing for modifications and growth as the application evolves. This involves designing the schema in a way that new entities, attributes, and relationships can be added with minimal disruption to existing structures.

In some embodiments, the level of completeness of an application's schema is determined by several key characteristics. Firstly, the schema's coverage of all necessary entities and relationships within the application domain is essential. This includes defining all relevant tables, fields, and their data types, ensuring that every aspect of the application's data requirements is addressed. Secondly, the schema should include comprehensive constraints and validations, such as primary keys, foreign keys, unique constraints, and check constraints, to maintain data integrity and consistency. Additionally, it should incorporate indexing strategies to optimize query performance. Documentation is another crucial characteristic, where the schema should be well-documented with clear descriptions of each entity and attribute, including their purpose and usage. Furthermore, adherence to best practices and standards, such as normalization rules and naming conventions, is vital to ensure the schema is both efficient and maintainable. Finally, the schema's extensibility and scalability should be considered, allowing for future growth and changes without requiring significant rework. Together, these characteristics contribute to a robust, reliable, and complete schema that effectively supports the application's functionality and performance.

The system may then select a first database engine, from the first subset of database engines, based on the percentage of completeness of the schema. The system may then format the application for support by the first database engine. For example, the system may format an application for support by a database engine involves a series of steps designed to ensure seamless integration, optimal performance, and data integrity. The process may include with a thorough analysis of the application's requirements, including data types, relationships, transaction volumes, and query complexity. This analysis helps in designing an appropriate database schema that aligns with the application's needs. The system may define the data model, which involves identifying the entities (tables), their attributes (columns), and the relationships between them. This model serves as the blueprint for the database schema. For relational databases, this means creating tables with primary and foreign keys to enforce data integrity and relationships. For NoSQL databases, this might involve designing collections and documents that efficiently store hierarchical or unstructured data.

The system may normalize the data schema to eliminate redundancy and ensure consistency. This process involves organizing the data into tables or collections in a way that minimizes duplication and dependencies. For relational databases, normalization typically involves decomposing tables into smaller, related tables. For NoSQL databases, the focus is on designing denormalized schemas that optimize read and write operations for specific use cases.

Once the schema is defined and normalized, the system generates the necessary database scripts to create and initialize the database. These scripts include table or collection creation statements, index creation statements to enhance query performance, and constraints to enforce data integrity rules. Additionally, any necessary stored procedures, triggers, or functions are created to handle complex business logic and data transformations within the database.

The application code is then configured to interact with the database engine. This involves setting up the database connection parameters, such as the database server address, port, credentials, and any necessary connection pooling settings. The application's data access layer is implemented using appropriate APIs or frameworks that abstract the database interactions, such as JDBC for Java applications, Entity Framework for. NET applications, or ORM libraries like Hibernate or SQLAlchemy.

To ensure optimal performance, the system may also implement caching mechanisms, where frequently accessed data is temporarily stored in memory to reduce database load and improve response times. Additionally, query optimization techniques are applied, such as using prepared statements, optimizing join operations, and fine-tuning indexes based on query patterns. The system may include comprehensive error handling and logging mechanisms to monitor database interactions and handle any exceptions or errors gracefully. This ensures that any issues with database operations are quickly identified and resolved, maintaining the application's stability and reliability.

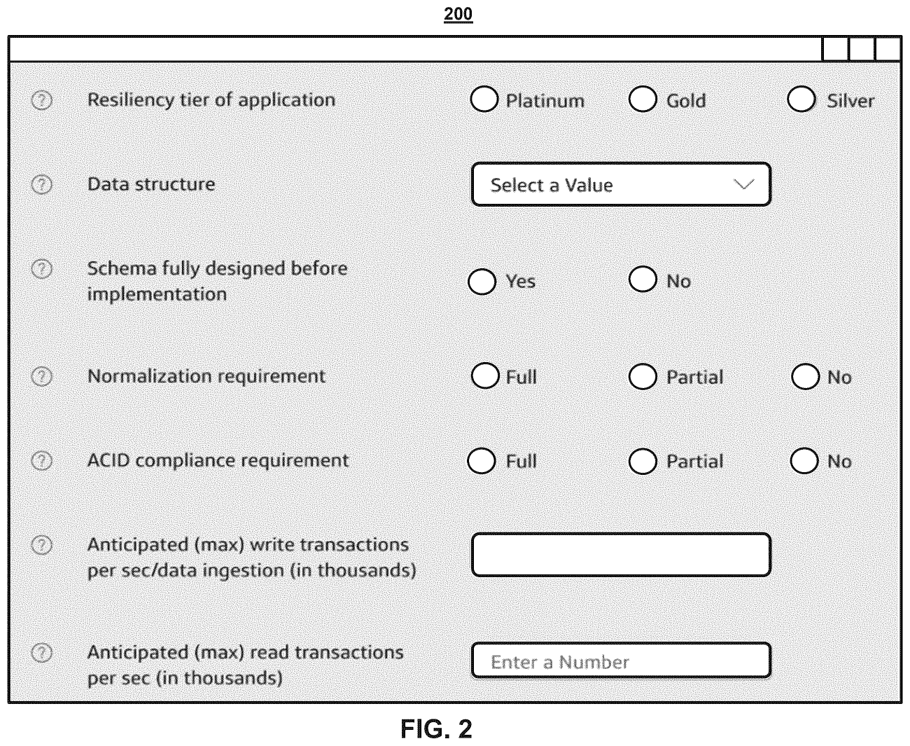

FIG. 2 shows an illustrative diagram for a user interface used to receive application requirements, in accordance with one or more embodiments. For example, FIG. 2 may include user interface 200, which may be used to facilitate fit-for-purpose database selection based on application characteristics and development timelines of applications currently under development.

As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

User interface 200 may receive, via a first user input to user interface 200, a database processing requirement for the application, wherein the database processing requirement is based on whether a potential database engine supports real-time processing, batch processing, or mix processing. For example, the system may receive one or more requirements for an application. When selecting a database engine, a user must consider several key requirements of their application to ensure optimal performance, scalability, and reliability. One of the primary requirements is data volume and storage capacity. The user needs to assess the amount of data the application will handle, both currently and in the future, to choose a database engine that can efficiently manage large datasets without compromising performance.

Another requirement is the complexity and nature of the queries. Applications that perform complex queries involving multiple joins, aggregations, or analytical processing need a database engine with advanced query optimization and indexing capabilities. Conversely, if the queries are relatively simple and straightforward, the user might prioritize other factors, such as cost or ease of use. Transaction processing is another requirement. Applications that require high transaction throughput with robust Atomicity, Consistency, Isolation, Durability (ACID) properties, such as financial systems or e-commerce platforms, necessitate a relational database engine known for its strong transaction management. On the other hand, applications that prioritize availability and can tolerate eventual consistency, such as social media platforms or content management systems, may benefit from a NoSQL database.

Scalability requirements also play a significant role in database engine selection. If the application is expected to grow rapidly, the user must choose a database engine that can scale horizontally across multiple servers or vertically by upgrading hardware. This ensures the application can handle increased loads and data growth without significant performance degradation.

Additionally, the application's data structure is relevant. For applications dealing with structured data and predefined schemas, relational databases are often suitable. In contrast, applications handling unstructured or semi-structured data, such as JSON documents or hierarchical data, may benefit from the flexibility of NoSQL databases. Performance requirements, including response time and throughput, are also essential. Applications needing real-time data access and low-latency responses, such as gaming or streaming services, require a high-performance database engine optimized for quick read and write operations. Security requirements are another critical consideration. Applications that handle sensitive or confidential data, such as healthcare or financial applications, need a database engine with robust security features, including encryption, access control, and audit logging. Compatibility with existing technology stacks and the development team's expertise can influence the choice. The selected database engine should integrate seamlessly with the application's architecture and be familiar to the development team to minimize learning curves and implementation challenges.

For example, the system may filter the plurality of database engines based on the database processing requirement to generate a first subset of database engines that support real-time processing, batch processing, or mix processing. The system may then determine a first characteristic of a schema of the application, wherein the first characteristic comprises a percentage of tables currently defined within an application domain of the application.

Following the selection, system 106 may generate for display, on a user interface a recommendation for the first database engine. This recommendation may be ranked, with the top database engine being the best fit for the given requirements. The system also prepares a detailed rationale for the recommendation, explaining why a particular database engine is suitable based on the application's specific needs.

The recommendation may then format for display on user interface 200. The interface may be designed to be user-friendly and intuitive, often incorporating visual elements such as charts, graphs, and comparison tables to help users understand the recommendation. The display includes the name of the recommended database engine, a brief description of its key features and benefits, and a comparison with other potential options. Additionally, the interface may provide interactive elements, allowing users to adjust their application requirements and see how these changes affect the recommendation in real-time. This dynamic feature helps users explore different scenarios and understand the trade-offs between various database engines.

The system may ensure that the recommendation is easily accessible and visually appealing, using a clean layout and clear language. The goal is to provide users with actionable insights and facilitate informed decision-making. By presenting the recommendation in a concise, well-organized manner, the system enhances the user experience and supports effective selection of the database engine. For example, the system may receive, via a second user input to the user interface, an acceptance of the recommendation.

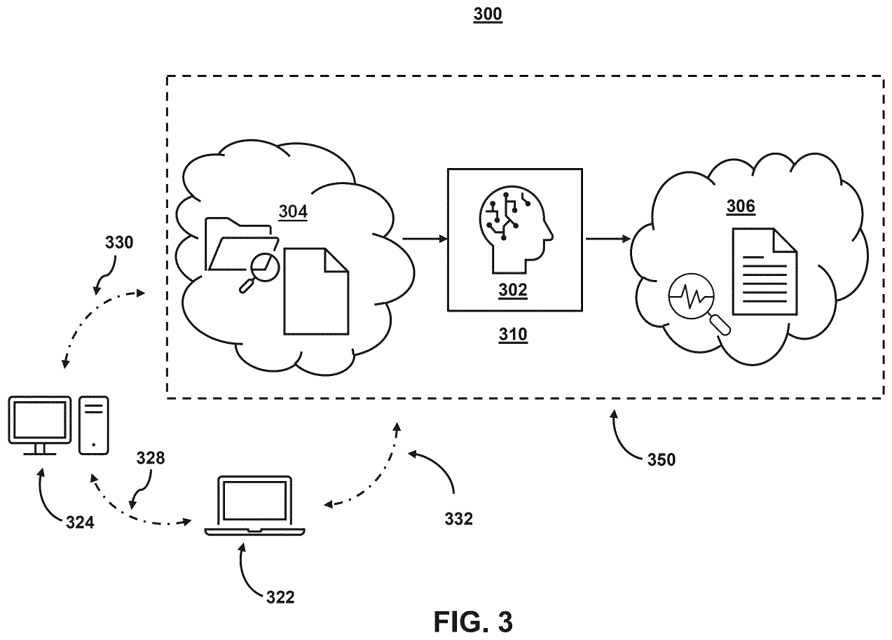

FIG. 3 shows illustrative components for a system used for database selection, in accordance with one or more embodiments. For example, FIG. 3 may show illustrative components for fit-for-purpose database selection based on application characteristics and development timelines of applications currently under development. As shown in FIG. 3, system 300 may include mobile device 322 and user terminal 324. While shown as a laptop and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice, or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., potential new application features, potential product application deadlines, potential database changes, and/or likelihoods thereof).

For example, the system may train a model to select database engines for applications. For example, the system may retrieve a comprehensive dataset comprising various application features, product application deadlines, database changes, and their associated likelihoods. Each feature input in this dataset may be labeled with known predictions, such as potential new application features, deadlines, database changes, and their likelihoods. The system may preprocess this data, which involves cleaning and normalizing the data to ensure consistency and accuracy. This may also include feature extraction and transformation to convert raw data into a suitable format for the model.

Once the data is prepared, the system may employ artificial intelligence algorithms to train the model. This involves feeding the labeled feature inputs into the model and adjusting its parameters to minimize the prediction error. During training, the model learns to recognize patterns and correlations between the input features and the correct database engine selection. Techniques such as supervised learning can be particularly effective, where the model is trained on a labeled dataset that includes both the features and the correct outcomes.

The training process may involve splitting the dataset into training and validation sets. The model is trained on the training set and validated on the validation set to ensure it generalizes well to unseen data. Various algorithms, such as decision trees, random forests, or neural networks, can be employed depending on the complexity of the task and the nature of the data. Hyperparameter tuning may also be used, as it involves selecting the optimal settings for the algorithm to improve model performance.

After training, the model may be tested on a separate test set to evaluate its accuracy and effectiveness in predicting the appropriate database engine based on new feature inputs. Once validated, the trained model can be deployed in a production environment, where it can analyze new applications, predict their future features and requirements, and recommend the most suitable database engine accordingly. This approach ensures that the system can adapt to evolving application needs and make informed decisions that enhance performance and scalability.

Model 302 may determine the likelihood of potential new application features, product application deadlines, and/or database changes through a combination of data analysis, pattern recognition, and predictive modeling. The system may determine a robust dataset that includes historical data on previous applications, feature updates, product timelines, and database changes. This data must be rich in detail and accurately labeled to train the model effectively.

The system may be trained using supervised learning, where it learns to map input features (such as current application specifications, development progress, market trends, and historical data) to the likelihood of specific outcomes. During training, the model continuously adjusts its parameters to minimize prediction errors and improve accuracy. Techniques like cross-validation ensure that the model generalizes well to unseen data by preventing overfitting.

To enhance its predictive capabilities, the model may incorporate additional data sources, such as user feedback, market analysis, and technological advancements. This holistic approach allows the model to consider a wide range of factors that could influence future application features and timelines. Advanced models might also use deep learning techniques, such as recurrent neural networks (RNNs) or long short-term memory (LSTM) networks, which are particularly effective in handling sequential data and capturing temporal dependencies.

Once trained, model 302 can analyze new data inputs and predict the likelihood of potential new features, deadlines, and database changes with a high degree of accuracy. These predictions help the system make informed decisions, prioritize tasks, and/or allocate resources efficiently, ultimately leading to more robust and timely application development. By continuously learning from new data, the model adapts to changing trends and remains relevant in a dynamic development environment.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation, and inhibition for model 302 may be more free-flowing, with connections interacting in a more chaotic and complex fashion. During testing, an output layer of model 302 may indicate whether or not a given input corresponds to a classification of model 302 (e.g., potential new application features, potential product application deadlines, potential database changes, and/or likelihoods thereof).

In some embodiments, the model (e.g., model 302) may automatically perform actions based on outputs 306. In some embodiments, the model (e.g., model 302) may not perform any actions. The output of the model (e.g., model 302) may be used to select potential new application features, potential product application deadlines, potential database changes, and/or likelihoods thereof.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web service APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

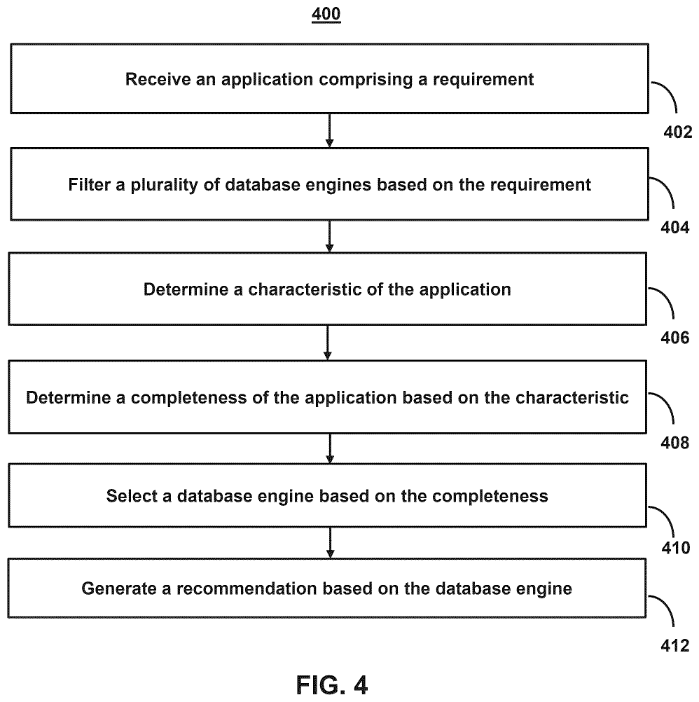

FIG. 4 shows a flowchart of the steps involved in database selection, in accordance with one or more embodiments. For example, the system may use process 400 (e.g., as implemented on one or more system components described above) for fit-for-purpose database selection based on application characteristics and development timelines of applications currently under development.

At step 402, process 400 (e.g., using one or more components described above) receive an application comprising a requirement. For example, the system may receive an application for fitting to one of a plurality of database engines based on a requirement for the application. The system may provide an interface (e.g., user interface 200 (FIG. 2)) where users can submit their application details. This interface may include forms or interactive questionnaires designed to capture a comprehensive set of requirements, such as data volume, query complexity, transaction processing needs, scalability, data structure, performance expectations, and security considerations. Users may input specific details about their application, such as expected data size, types of queries and transactions, frequency and volume of data access, anticipated growth, and any particular constraints or preferences. The system may also ask for information about the existing technology stack, the development team's expertise, and any regulatory or compliance requirements that the application must meet. Once the application details are submitted, the system may process this information to create a detailed profile of the application's needs. It uses this profile to evaluate and compare the features of various database engines available in its database. This evaluation involves matching the application's requirements with the capabilities of each database engine, considering factors like performance benchmarks, scalability options, data model support, transaction handling, and security features.

At step 404, process 400 (e.g., using one or more components described above) filter a plurality of database engines based on the requirement. For example, the system may filter the plurality of database engines based on the requirement to generate a first subset of database engines. For example, the system may employ algorithms, which may include rule-based logic or models trained on historical data, to rank and/or otherwise file database engines based on how well they meet the application's requirements. These algorithms analyze the input data to identify the best fit among the available options, ensuring that the selected database engine can handle the specific needs of the application efficiently and effectively. After processing and analysis, the system generates a list of recommended database engines, ranked by their suitability for the application. The top recommendation is usually the database engine that best aligns with the application's requirements, while alternative options are provided to give users flexibility in their choice.

In some embodiments, the system may filter the plurality of database engines based on the requirement to generate the first subset of database engines by determining that the requirement is based on whether a potential database engine supports real-time processing, batch processing, or mix processing and determining that the first subset of database engines support real-time processing, batch processing, or mix processing. For example, the system may gather information about the application's processing requirements. This includes understanding whether the application primarily needs real-time processing, which involves handling data and queries with minimal latency for immediate results; batch processing, which involves handling large volumes of data in scheduled intervals; or mixed processing, which requires a combination of both real-time and batch processing capabilities. Once the processing requirements are clearly defined, the system examines the capabilities of the available database engines. It analyzes the features and performance characteristics of each engine to determine their suitability for real-time, batch, or mixed processing. The system then filters the available database engines by matching their capabilities to the application's processing requirements. It creates a list of engines that can handle the specified type of processing, whether it is real-time, batch, or mixed.

In some embodiments, the system may filter the plurality of database engines based on the requirement to generate the first subset of database engines by determining that the requirement is based on whether a potential database engine supports a non-structured data model and determining that the first subset of database engines supports the non-structured data model. The system may gather detailed information about the application's data model requirements. Non-structured data refers to data that does not fit into traditional relational databases with predefined schemas. This includes data types such as JSON documents, XML files, multimedia content, and other forms of flexible, schema-less data. The requirement for supporting a non-structured data model indicates that the application needs a database engine capable of handling such diverse and flexible data formats. The system then evaluates the capabilities of the available database engines.

In some embodiments, the system may filter the plurality of database engines based on the requirement to generate the first subset of database engines by determining that the requirement is based on whether a potential database engine supports a predetermined read and/or write rate and determining that the first subset of database engines support the predetermined read and/or write rate. For example, the system may collect detailed information about the application's performance requirements. This includes the expected read and write rates, typically measured in transactions per second (TPS), queries per second (QPS), or data throughput in terms of megabytes or gigabytes per second. These metrics provide a clear target for the database engine's performance capabilities. The system may then assess the performance capabilities of the available database engines.

In some embodiments, the system may filter the plurality of database engines based on the requirement to generate the first subset of database engines by determining that the requirement is based on whether a potential database engine is cloud native, open source, and/or specific to a given platform and determining that the first subset of database engines is cloud native, open source, and/or specific to a given platform. For example, the system may collect detailed information about the application's deployment and platform requirements. This includes understanding whether the application needs a cloud-native solution, prefers open-source technologies, or requires a database engine specific to a given platform (such as a particular operating system or cloud provider). Additionally or alternatively, the system may identify database engines that are designed to be cloud native. These engines typically offer features such as automatic scaling, high availability, managed services, and integration with cloud infrastructure. Cloud-native databases are optimized for deployment on cloud platforms and are often provided as Database-as-a-Service (DBaaS) offerings. Additionally or alternatively, the system may evaluate which database engines are open source. Open-source databases provide the benefits of transparency, community support, and flexibility in customization. They allow organizations to inspect the source code, contribute to the development, and avoid vendor lock-in. Additionally or alternatively, the system may identify database engines that are specific to a given platform. This includes databases optimized for particular operating systems, hardware architectures, or cloud providers. For instance, some databases are designed to leverage the unique features of a specific cloud environment or to run efficiently on specific server configurations. The system then filters the database engines based on the application's requirements. For example, if the application needs a cloud-native solution, the system excludes any databases that are not designed for cloud environments. If the application prefers open-source technologies, the system excludes proprietary or closed-source databases. If the application requires a database specific to a given platform, the system filters out those that do not support or optimize for that platform. After filtering based on these criteria, the system generates a first subset of database engines that meet the specified requirements. This subset includes only those engines that align with the application's need for being cloud native, open source, and/or platform specific.

In some embodiments, the system may filter the plurality of database engines based on the requirement to generate the first subset of database engines by determining that the requirement is based on whether a potential database engine supports a predetermined transactions per second (TPS) calculation and determining that the first subset of database engines support the predetermined transaction per second calculation. For example, the system may review performance benchmarks for each database engine, focusing on TPS metrics. These benchmarks are often provided by database vendors or derived from industry-standard tests such as Transaction Processing Performance Council (TPC) benchmarks. The system may look at results from performance testing and stress testing conducted in real-world scenarios or controlled environments. These tests simulate high transaction loads to evaluate how well the database engine can maintain its performance under stress. The system may evaluate the scalability features of each database engine, such as horizontal and vertical scaling capabilities, which enable the engine to maintain high TPS as data volume and user load increase. The system may evaluate the scalability features of each database engine, such as horizontal and vertical scaling capabilities, which enable the engine to maintain high TPS as data volume and user load increase. The system may consider the latency (time taken to process individual transactions) and overall throughput (total transactions processed in a given time period) of each database engine, ensuring that both metrics align with the required TPS. Based on these performance indicators, the system filters out database engines that do not meet the predetermined TPS requirement. This involves excluding engines that fail to sustain the required TPS under typical and peak load conditions, focusing on those that consistently perform well in benchmarks and real-world tests.

In some embodiments, the system may filter the plurality of database engines based on the requirement to generate the first subset of database engines by determining that the requirement is based on whether a potential database engine supports a plugin access and determining that the first subset of database engines support the plugin access. For example, the system may collect information about the application's requirement for plugin access. Plugins allow for extending the functionality of the database engine, enabling customization and integration with other tools and systems. The requirement for plugin support indicates that the application needs a flexible and extensible database engine that can be tailored to specific needs through additional modules or extensions. The system may evaluate the capabilities of the available database engines regarding plugin support. The system may examine each engine's architecture and features to determine how well they facilitate the development, integration, and management of plugins.

At step 406, process 400 (e.g., using one or more components described above) determines a characteristic of the application. For example, the system may determine a first characteristic of a schema of the application. To determine the characteristic of the schema, the system may access schema definitions, which can be provided in various formats such as SQL Data Definition Language (DDL) scripts, JSON schema files, or through direct introspection of an existing database. For example, the system may parse the schema definition to extract essential elements such as tables (or collections in NoSQL databases), columns (or fields), data types, primary keys, foreign keys, indexes, and other constraints. For relational databases, this involves identifying tables and their columns, along with their respective data types (e.g., integers, strings, dates), and understanding the relationships between tables through primary and foreign keys. In NoSQL databases, the system examines collections and documents to determine the structure and types of the data stored within. The system may analyze these elements to understand the schema's complexity and how it impacts the application's data management needs. It evaluates the number and types of relationships between entities, such as one-to-one, one-to-many, and many-to-many relationships, which influence how queries are constructed and optimized. The system also assesses the use of indexes, which play a crucial role in query performance by enabling faster data retrieval. The system may examine constraints and rules defined within the schema, such as unique constraints, not-null constraints, and default values. These constraints are important for maintaining data integrity and ensuring that the data adheres to specific business rules. The presence of triggers, stored procedures, and other database-specific features is also noted, as they can impact the choice of database engine and its configuration. The system may consider the schema's scalability requirements by analyzing the expected data volume and growth patterns. This includes understanding the size of individual tables or collections, the frequency of data updates, and the historical growth trends if available. This information helps in determining whether the current schema design can support future expansion without significant performance degradation. The system may also perform sample data profiling, where it analyzes a subset of the actual data to gain insights into data distribution, cardinality, and potential anomalies. This profiling helps in fine-tuning the schema analysis by providing a more accurate representation of how the schema will be used in practice. After gathering and analyzing all these characteristics, the system synthesizes the information to form a comprehensive understanding of the schema. This understanding is then used to inform decisions about the most suitable database engine, ensuring that it can efficiently handle the specific data structures, relationships, constraints, and scalability needs of the application.

The system may determine the first characteristic of a schema of the application by determining a percentage of tables currently defined within an application domain of the application and determining a first characteristic of a schema of the application based on the percentage. For example, the system determines the number of tables that have been implemented and defined within the current schema. This involves querying the database or examining the schema files to count the tables that exist and have been populated with the necessary columns, relationships, and constraints. By comparing the number of defined tables to the total number of planned tables, the system calculates the percentage of schema completeness. For example, if an application domain is designed to have 100 tables and 75 tables are currently defined, the system determines that the schema is 75% complete. This percentage serves as a key indicator of the schema's maturity and the application's overall progress. The system then uses this percentage to determine the first characteristic of the schema, which can include insights into the schema's stability, complexity, and readiness for performance tuning and optimization. For instance, a high percentage of schema completeness (e.g., above 80%) suggests that the schema is relatively mature, with most of the data structures in place. This characteristic indicates that the application is likely entering a phase where performance optimization, indexing strategies, and query tuning become critical. The system might infer that the application is ready for detailed performance analysis and database engine optimization based on the current schema. On the other hand, a lower percentage of schema completeness (e.g., below 50%) indicates that the schema is still under active development, with many tables and relationships yet to be defined. This characteristic suggests that the application is in an earlier stage of development where flexibility and ease of schema modifications are more important. The system might infer that a database engine with strong support for dynamic schema changes and schema migrations would be more suitable at this stage.

In some embodiments, the system may determine the first characteristic of a schema of the application by determining a percentage of constraints defined within an application domain of the application and determining a first characteristic of a schema of the application based on the percentage. For example, the system may determine the number of constraints that have been implemented and defined within the current schema. This involves querying the database or examining the schema files to count the constraints that exist and have been correctly set up to ensure data integrity. By comparing the number of defined constraints to the total number of planned constraints, the system calculates the percentage of schema completeness concerning constraints. For example, if an application domain is designed to have 200 constraints and 150 constraints are currently defined, the system determines that the schema is 75% complete in terms of constraints. This percentage serves as a key indicator of the schema's maturity and the application's overall progress in enforcing data integrity and business rules. The system then uses this percentage to determine the first characteristic of the schema, which can include insights into the schema's stability, complexity, and readiness for rigorous data integrity checks and performance tuning. For instance, a high percentage of constraint completeness (e.g., above 80%) suggests that the schema is relatively mature, with most data integrity rules and relationships in place. This characteristic indicates that the application is likely entering a phase where ensuring data consistency and optimizing database performance become critical. The system might infer that the application is ready for detailed performance analysis and database engine optimization based on the current schema's constraints. On the other hand, a lower percentage of constraint completeness (e.g., below 50%) indicates that the schema is still under active development, with many constraints and relationships yet to be defined. This characteristic suggests that the application is in an earlier stage of development where flexibility and ease of schema modifications are more important. The system might infer that a database engine with strong support for dynamic schema changes, easy constraint addition, and schema migrations would be more suitable at this stage. By determining this first characteristic based on the percentage of constraints currently defined, the system provides valuable insights into the application's development phase and schema maturity. These insights help guide decisions related to database engine selection, schema optimization, and overall application development strategy.

In some embodiments, the system may determine the first characteristic of a schema of the application by determining a percentage of fields populated within an application domain of the application and determining a first characteristic of a schema of the application based on the percentage. For example, the system may determine the number of fields that have been populated with data within the current schema. This involves querying the database to count the fields that contain data values as opposed to being empty or null. This step may include analyzing sample data sets or the entire database to get an accurate measure of data population. By comparing the number of populated fields to the total number of planned fields, the system calculates the percentage of schema completeness concerning data population. For example, if an application domain is designed to have 1,000 fields and 750 fields are currently populated with data, the system determines that the schema is 75% complete in terms of field population. This percentage serves as a key indicator of the schema's maturity and the application's overall progress in data readiness. The system then uses this percentage to determine the first characteristic of the schema, which can include insights into the schema's stability, complexity, and readiness for further development stages such as testing, optimization, and deployment. For instance, a high percentage of field population completeness (e.g., above 80%) suggests that the schema is relatively mature, with most of the necessary data attributes populated. This characteristic indicates that the application is likely entering a phase where performance optimization, rigorous testing, and fine-tuning become critical. The system might infer that the application is ready for detailed performance analysis, query optimization, and database tuning based on the current state of data population. On the other hand, a lower percentage of field population completeness (e.g., below 50%) indicates that the schema is still under active development, with many data attributes yet to be populated. This characteristic suggests that the application is in an earlier stage of development where flexibility in data handling and ease of data insertion are more important. The system might infer that a database engine with strong support for bulk data loading, flexible schema modifications, and efficient data insertion mechanisms would be more suitable at this stage. By determining this first characteristic based on the percentage of fields currently populated, the system provides valuable insights into the application's development phase and data readiness. These insights help guide decisions related to database engine selection, data management strategies, and overall application development planning.

In some embodiments, the system may determine the first characteristic of a schema of the application by determining a number of primary keys defined within an application domain of the application and determining a first characteristic of a schema of the application based on the number. The system may access the schema definition, which could be stored in various formats such as SQL DDL scripts, database metadata, or schema files. The system may then parse this definition to identify all the primary keys within the schema. Primary keys are crucial for uniquely identifying records in a table and ensuring that each record can be efficiently accessed and managed. They are fundamental to maintaining data integrity and establishing relationships between different tables in the schema. The system may count the total number of primary keys defined in the schema. This involves querying the database or examining the schema files to identify each table and its primary key. The presence of primary keys indicates that the schema has been designed with data integrity and relational database principles in mind. By analyzing the number of primary keys, the system may determine the schema's complexity and its readiness for further development stages. For example, a schema with a high number of primary keys spread across various tables suggests a well-structured and normalized database design, where each table has a unique identifier ensuring data consistency and integrity. This information is used to infer the first characteristic of the schema, which can provide insights into the schema's maturity, stability, and relational structure. For instance, if the schema has a significant number of primary keys, it indicates that the application is likely to have a complex relational database structure, with well-defined relationships between entities. This characteristic suggests that the schema is mature and has been designed with careful consideration of data relationships and integrity constraints. On the other hand, if the number of primary keys is low or primary keys are missing from many tables, it may indicate an incomplete or evolving schema. This could suggest that the schema is still under active development, with more work needed to ensure data integrity and proper relational design. In such cases, the system might infer that the application is in an earlier stage of development, where flexibility in schema design and the ability to make changes quickly are more important. By determining this first characteristic based on the number of primary keys, the system provides valuable insights into the application's development phase and database design quality. These insights help guide decisions related to database engine selection, schema optimization, and overall application development strategy.

In some embodiments, the system may determine the first characteristic of a schema of the application by determining a plurality of entities defined within an application domain of the application, determining a number of entities of the plurality of entities that are currently defined, and determining a first characteristic of a schema of the application based on the number of entities of the plurality of entities that are currently defined. For example, the system may access the schema definition, which can be stored in various formats such as SQL DDL scripts, database metadata, or schema files. It parses this definition to identify all the entities planned for the application's domain. Entities typically correspond to tables in a relational database or collections in a NoSQL database, representing the primary data objects around which the schema is structured. The system may count the total number of planned entities, as specified in the project requirements or design documents. This count provides a baseline for assessing the completeness of the schema. The system then examines the current implementation of the schema to determine how many of these planned entities have been defined and implemented. This involves querying the database or examining the schema files to count the entities that exist and are populated with the necessary fields, relationships, and constraints. By comparing the number of implemented entities to the total number of planned entities, the system calculates the percentage of schema completeness concerning entity definition. For example, if the application domain is designed to have 50 entities and 40 entities are currently defined, the system determines that the schema is 80% complete in terms of entity implementation. This percentage serves as a key indicator of the schema's maturity and the application's overall progress. The system then uses this percentage to determine the first characteristic of the schema, which can include insights into the schema's stability, complexity, and readiness for further development stages such as testing, optimization, and deployment. For instance, a high percentage of entity completeness (e.g., above 80%) suggests that the schema is relatively mature, with most of the data structures in place. This characteristic indicates that the application is likely entering a phase where performance optimization, rigorous testing, and fine-tuning become critical. The system might infer that the application is ready for detailed performance analysis and database tuning based on the current state of entity implementation. On the other hand, a lower percentage of entity completeness (e.g., below 50%) indicates that the schema is still under active development, with many entities yet to be defined. This characteristic suggests that the application is in an earlier stage of development where flexibility and ease of schema modifications are more important. The system might infer that a database engine with strong support for dynamic schema changes, easy entity addition, and schema migrations would be more suitable at this stage. By determining this first characteristic based on the number of entities currently defined, the system provides valuable insights into the application's development phase and schema maturity. These insights help guide decisions related to database engine selection, schema optimization, and overall application development strategy.

At step 408, process 400 (e.g., using one or more components described above) determines a completeness of the application based on the characteristic. For example, the system may determine a percentage of completeness of the schema based on the first characteristic. For example, the system may determine the completeness of an application in development by evaluating multiple aspects of the application's progress, functionality, and/or adherence to specified requirements. This evaluation process involves a combination of automated tools, predefined metrics, and continuous monitoring. For example, the system may review the application's feature set against the project requirements and specifications. It checks whether all planned features have been implemented and whether they function as intended. This involves comparing the current state of the application with a detailed project plan or backlog, which outlines the features, user stories, and tasks that need to be completed.

Additionally or alternatively, the system may assess the application's codebase for completeness. This includes analyzing code coverage through automated testing tools to ensure that a significant portion of the code has been tested. Unit tests, integration tests, and end-to-end tests are run to validate that the application behaves correctly under various scenarios. The system also checks for unresolved issues or bugs in the issue tracker, ensuring that critical and high-priority bugs have been addressed. Additionally or alternatively, the system evaluates the completeness of the database schema and data models. It verifies that the schema design aligns with the application's requirements, that all necessary tables, relationships, and constraints are in place, and that sample data or test data has been correctly populated. The system may use data profiling tools to ensure data integrity and consistency across the database.

Additionally or alternatively, the system may monitor the user interface (UI) and user experience (UX) aspects of the application. The system may check that all UI components are in place, function correctly, and provide a seamless user experience. This may involve automated UI testing tools that simulate user interactions and verify that the application responds appropriately. Furthermore, the system may review documentation and deployment readiness. The system may ensure that all necessary documentation, such as user manuals, API documentation, and deployment guides, is complete and up to date. The system may also check that the application can be successfully deployed in the target environment, verifying configuration settings, dependency management, and deployment scripts. Project management tools integrated with the system provide additional insights into completeness by tracking progress metrics such as task completion rates, sprint velocity, and milestone achievements. These tools help gauge whether the development is on schedule and whether remaining tasks can be completed within the planned timeframe.

At step 410, process 400 (e.g., using one or more components described above) selects a database engine based on the completeness. For example, the system may select a first database engine, from the first subset of database engines, based on the percentage of completeness of the schema. For example, the system may calculate the percentage of completeness of the schema by comparing the implemented schema elements—such as tables, columns, relationships, constraints, and indexes—against the planned schema as outlined in the project requirements. This completeness metric provides an indication of how much of the schema has been developed and tested. Once the percentage of completeness is determined, the system assesses the current and projected requirements of the application based on the schema's state. For example, if the schema is nearly complete, the system might prioritize database engines that excel in performance optimization and scalability for the existing data structure. Conversely, if the schema is still evolving significantly, the system might favor database engines known for their flexibility and ease of schema modifications.

In some embodiments, the system may select the first database engine, from the first subset of database engines, based on the percentage of completeness of the schema by scoring each database engine of the first subset of database engines based on the percentage of completeness of the schema and selecting the first database engine based on a scored corresponding to the first database engine. For example, the system may select the first database engine from a subset of database engines based on the percentage of completeness of the schema by employing a scoring mechanism that evaluates each engine according to how well it aligns with the application's current and anticipated requirements. The system may calculate the percentage of schema completeness, which reflects how much of the database schema has been developed and tested compared to the planned design. For example, once the completeness percentage is determined, the system may use this metric to weigh various criteria relevant to database engine selection. These criteria typically include schema support, performance optimization, scalability, ease of schema evolution, and developer familiarity. The weight assigned to each criterion varies depending on the completeness percentage. For instance, if the schema is nearly complete, more weight is given to performance and optimization features. Conversely, if the schema is still evolving, flexibility and ease of schema modification are prioritized. The system may then score each database engine in the subset based on these weighted criteria. For schema support, the system assesses how well each engine handles the current data structures, relationships, and constraints defined in the schema. Performance optimization is evaluated based on the engine's capabilities for indexing, query optimization, and transaction handling, especially important if the schema is largely developed. Scalability is scored based on the engine's ability to manage growing data volumes and increased load, crucial for applications with rapidly expanding data. Flexibility and ease of schema evolution may be particularly important if the schema is incomplete. The system scores engines on their ability to accommodate schema changes without significant disruption. This includes support for schema migrations, dynamic schema updates, and handling unstructured or semi-structured data. Developer familiarity and the surrounding ecosystem may also be scored, considering the development team's expertise with the engine and the availability of tools, documentation, and community support. After scoring each database engine based on these criteria, the system may aggregate the scores to produce a final rating for each engine. The database engine with the highest aggregated score is selected as the first database engine, as it best meets the application's current needs while providing the necessary flexibility or optimization based on the schema completeness.

At step 412, process 400 (e.g., using one or more components described above) generates a recommendation based on the database engine. For example, the system may generate for display, on a user interface a recommendation for the first database engine. The recommendation may be displayed on the user interface in a clear and organized manner. The recommendation may include a concise summary at the top of the interface indicates the recommended database engine, emphasizing its alignment with the application's requirements.

Additionally or alternatively, below the summary, the system may provide a detailed explanation, outlining why the recommended database engine is the best fit. This section may highlight how the engine meets specific criteria such as performance, scalability, data integrity, and ease of integration. Additionally or alternatively, the system may provide a comparison table that presents a side-by-side evaluation of the top database engines considered. This table may include key features, strengths, and weaknesses of each engine, helping users understand the trade-offs. Additionally or alternatively, the system may provide interactive elements such as filters and sliders, allowing users to adjust their application requirements and see how these changes impact the recommendation. This dynamic feature may help users explore different scenarios and make more informed decisions. Additionally or alternatively, the system may provide visual aids such as charts, graphs, and/or icons to visualize key data points and comparisons, making the information more accessible and easier to understand at a glance. Additionally or alternatively, the system may provide links to additional resources, such as documentation, case studies, or tutorials for the recommended database engine, to help users gain deeper insights and facilitate implementation.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for fit-for-purpose database selection based on application characteristics of applications currently under development.
2. The method of any one of the preceding embodiments, further comprising receiving an application for fitting to one of a plurality of database engines based on a requirement for the application; filtering the plurality of database engines based on the requirement to generate a first subset of database engines; determining a first characteristic of a schema of the application; determining a percentage of completeness of the schema based on the first characteristic; selecting a first database engine, from the first subset of database engines, based on the percentage of completeness of the schema; and generating for display, on a user interface a recommendation for the first database engine.
3. The method of any one of the preceding embodiments, wherein selecting the first database engine from the first subset of database engines, based on the percentage of completeness of the schema, further comprises scoring each database engine of the first subset of database engines based on the percentage of completeness of the schema; and selecting the first database engine based on a scored corresponding to the first database engine.
4. The method of any one of the preceding embodiments, wherein determining the first characteristic of a schema of the application further comprises determining a percentage of tables currently defined within an application domain of the application; and determining a first characteristic of a schema of the application based on the percentage.
5. The method of any one of the preceding embodiments, wherein determining the first characteristic of a schema of the application further comprises determining a percentage of constraints defined within an application domain of the application; and determining a first characteristic of a schema of the application based on the percentage.
6. The method of any one of the preceding embodiments, wherein determining the first characteristic of a schema of the application further comprises determining a percentage of fields populated within an application domain of the application; and determining a first characteristic of a schema of the application based on the percentage.
7. The method of any one of the preceding embodiments, wherein determining the first characteristic of a schema of the application further comprises determining a number of primary keys defined within an application domain of the application; and determining a first characteristic of a schema of the application based on the number.
8. The method of any one of the preceding embodiments, wherein determining the first characteristic of a schema of the application further comprises determining a plurality of entities defined within an application domain of the application; determining a number of entities of the plurality of entities that are currently defined; and determining a first characteristic of a schema of the application based on the number of entities of the plurality of entities that are currently defined.
9. The method of any one of the preceding embodiments, wherein filtering the plurality of database engines based on the requirement to generate the first subset of database engines further comprises determining that the requirement is based on whether a potential database engine supports real-time processing, batch processing, or mix processing; and determining that the first subset of database engines support real-time processing, batch processing, or mix processing.
10. The method of any one of the preceding embodiments, wherein filtering the plurality of database engines based on the requirement to generate the first subset of database engines further comprises determining that the requirement is based on whether a potential database engine supports a non-structured data model; and determining that the first subset of database engines supports the non-structured data model.
11. The method of any one of the preceding embodiments, wherein filtering the plurality of database engines based on the requirement to generate the first subset of database engines further comprises determining that the requirement is based on whether a potential database engine supports a predetermined read rate; and determining that the first subset of database engines support the predetermined read rate.
12. The method of any one of the preceding embodiments, wherein filtering the plurality of database engines based on the requirement to generate the first subset of database engines further comprises determining that the requirement is based on whether a potential database engine is cloud native; and determining that the first subset of database engines is cloud native.
13. The method of any one of the preceding embodiments, wherein filtering the plurality of database engines based on the requirement to generate the first subset of database engines further comprises determining that the requirement is based on whether a potential database engine supports a predetermined transaction per second calculation; and determining that the first subset of database engines support the predetermined transaction per second calculation.
14. The method of any one of the preceding embodiments, wherein filtering the plurality of database engines based on the requirement to generate the first subset of database engines further comprises determining that the requirement is based on whether a potential database engine supports a plugin access; and determining that the first subset of database engines support the plugin access.
15. The method of any one of the preceding embodiments, wherein filtering the plurality of database engines based on the requirement to generate the first subset of database engines further comprises determining that the requirement is based on whether a potential database engine is open source; and determining that the first subset of database engines is open source.
16. The method of any one of the preceding embodiments, wherein filtering the plurality of database engines based on the requirement to generate the first subset of database engines further comprises determining that the requirement is based on whether a potential database engine supports a predetermined write rate; and determining that the first subset of database engines support the predetermined write rate.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for fit-for-purpose database selection based on application characteristics and development timelines of applications currently under development, the system comprising:
one or more processors; and
one or more non-transitory, computer-readable mediums, comprising instructions that, when executed by the one or more processors, cause operations comprising:
receiving an application for fitting to one of a plurality of database engines for use by the application across a cloud computing network after deployment of the application;
receiving, via a first user input to a user interface, a database processing requirement for the application, wherein the database processing requirement is based on whether a potential database engine supports real-time processing, batch processing, or mix processing;
filtering the plurality of database engines based on the database processing requirement to generate a first subset of database engines that support real-time processing, batch processing, or mix processing;
determining a first characteristic of a schema of the application, wherein the first characteristic comprises a percentage of tables currently defined within an application domain of the application;
determining a percentage of completeness of the schema based on the first characteristic;
selecting a first database engine, from the first subset of database engines, based on the percentage of completeness of the schema;
generating for display, on a user interface a recommendation for the first database engine;
receiving, via a second user input to the user interface, an acceptance of the recommendation; and
formatting the application for support by the first database engine.

2. A method for fit-for-purpose database selection based on application characteristics of applications currently under development, the method comprising:
receiving an application for fitting to one of a plurality of database engines based on a requirement for the application;
filtering the plurality of database engines based on the requirement to generate a first subset of database engines;
determining a first characteristic of a schema of the application;
determining a percentage of completeness of the schema based on the first characteristic;
selecting a first database engine, from the first subset of database engines, based on the percentage of completeness of the schema; and
generating for display, on a user interface a recommendation for the first database engine.

3. The method of claim 2, wherein selecting the first database engine from the first subset of database engines, based on the percentage of completeness of the schema, further comprises:
scoring each database engine of the first subset of database engines based on the percentage of completeness of the schema; and
selecting the first database engine based on a scored corresponding to the first database engine.

4. The method of claim 2, wherein determining the first characteristic of a schema of the application further comprises:
determining a percentage of tables currently defined within an application domain of the application; and
determining a first characteristic of a schema of the application based on the percentage.

5. The method of claim 2, wherein determining the first characteristic of a schema of the application further comprises:
determining a percentage of constraints defined within an application domain of the application; and
determining a first characteristic of a schema of the application based on the percentage.

6. The method of claim 2, wherein determining the first characteristic of a schema of the application further comprises:
determining a percentage of fields populated within an application domain of the application; and
determining a first characteristic of a schema of the application based on the percentage.

7. The method of claim 2, wherein determining the first characteristic of a schema of the application further comprises:
determining a number of primary keys defined within an application domain of the application; and
determining a first characteristic of a schema of the application based on the number.

8. The method of claim 2, wherein determining the first characteristic of a schema of the application further comprises:
determining a plurality of entities defined within an application domain of the application;
determining a number of entities of the plurality of entities that are currently defined; and
determining a first characteristic of a schema of the application based on the number of entities of the plurality of entities that are currently defined.

9. The method of claim 2, wherein filtering the plurality of database engines based on the requirement to generate the first subset of database engines further comprises:
determining that the requirement is based on whether a potential database engine supports real-time processing, batch processing, or mix processing; and
determining that the first subset of database engines support real-time processing, batch processing, or mix processing.

10. The method of claim 2, wherein filtering the plurality of database engines based on the requirement to generate the first subset of database engines further comprises:
determining that the requirement is based on whether a potential database engine supports a non-structured data model; and
determining that the first subset of database engines supports the non-structured data model.

11. The method of claim 2, wherein filtering the plurality of database engines based on the requirement to generate the first subset of database engines further comprises:
determining that the requirement is based on whether a potential database engine supports a predetermined read rate; and
determining that the first subset of database engines support the predetermined read rate.

12. The method of claim 2, wherein filtering the plurality of database engines based on the requirement to generate the first subset of database engines further comprises:
determining that the requirement is based on whether a potential database engine is cloud native; and
determining that the first subset of database engines is cloud native.

13. The method of claim 2, wherein filtering the plurality of database engines based on the requirement to generate the first subset of database engines further comprises:
determining that the requirement is based on whether a potential database engine supports a predetermined transaction per second calculation; and
determining that the first subset of database engines support the predetermined transaction per second calculation.

14. The method of claim 2, wherein filtering the plurality of database engines based on the requirement to generate the first subset of database engines further comprises:
determining that the requirement is based on whether a potential database engine supports a plugin access; and
determining that the first subset of database engines support the plugin access.

15. The method of claim 2, wherein filtering the plurality of database engines based on the requirement to generate the first subset of database engines further comprises:
determining that the requirement is based on whether a potential database engine is open source; and
determining that the first subset of database engines is open source.

16. The method of claim 2, wherein filtering the plurality of database engines based on the requirement to generate the first subset of database engines further comprises:
determining that the requirement is based on whether a potential database engine supports a predetermined write rate; and
determining that the first subset of database engines support the predetermined write rate.

17. One or more non-transitory, computer-readable mediums, comprising instructions that, when executed by one or more processors, cause operations comprising:
receiving an application for fitting to one of a plurality of database engines based on a requirement for the application;
filtering the plurality of database engines based on the requirement to generate a first subset of database engines;
determining a first characteristic of a schema of the application;
determining a percentage of completeness of the schema based on the first characteristic; and
selecting a first database engine, from the first subset of database engines, based on the percentage of completeness of the schema.

18. The one or more non-transitory, computer-readable mediums of claim 17, selecting the first database engine, from the first subset of database engines, based on the percentage of completeness of the schema further comprises:
scoring each database engine of the first subset of database engines based on the percentage of completeness of the schema; and
selecting the first database engine based on a scored corresponding to the first database engine.

19. The one or more non-transitory, computer-readable mediums of claim 17, wherein determining the first characteristic of a schema of the application further comprises:
determining a percentage of tables currently defined within an application domain of the application; and
determining a first characteristic of a schema of the application based on the percentage.

20. The one or more non-transitory, computer-readable mediums of claim 17, wherein determining the first characteristic of a schema of the application further comprises:
determining a percentage of constraints defined within an application domain of the application; and
determining a first characteristic of a schema of the application based on the percentage.
